(19) United States
(12) Patent Application Publication
(10) Pub. No.: US 2025/0359558 A1
(43) Pub. Date: Nov. 27, 2025

(54) VEGAN DOUGH MASS, VEGAN EGG PASTRY SUBSTITUTE, MANUFACTURING METHOD FOR THE DOUGH MASS AND PRODUCTION METHOD FOR THE VEGAN EGG PASTRY SUBSTITUTE

(71) Applicant: Griesson - de Beukelaer GmbH & Co. KG, Polch (DE)

(72) Inventors: Kai Frederik MAHNKEN, Polch (DE); Fuad HAJJI, Polch (DE)

(73) Assignee: Griesson - de Beukelaer GmbH & Co. KG, Polch (DE)

(21) Appl. No.: 19/038,739

(22) Filed: Jan. 28, 2025

(30) Foreign Application Priority Data
Feb. 13, 2024 (EP) EP24157335.1

(51) Int. Cl. A21D 2/26; A21D 2/16; A21D 2/36; A21D 8/02; A21D 13/24; A21D 13/28; A21D 13/32

(52) U.S. Cl. CPC A21D 2/266; A21D 2/165; A21D 2/362; A21D 8/025; A21D 13/24; A21D 13/28; A21D 13/32

(57) ABSTRACT

A dough mass for the production of a vegan egg pastry substitute as a long-life baked product, wherein the dough mass contains the following ingredients with the stated mass fractions of the dough mass: from 20% to 40% of flour, from 15% to 35% of sugar, from 10% to 30% of water, from 5% to 10% of vegetable fat and from 2.5% to 10% of a humectant. The dough mass contains a vegetable protein ingredient with a mass fraction of the dough mass of 1% to 5%. The disclosure further relates to a vegan egg pastry substitute with the baked dough mass, a manufacturing method for manufacturing the dough mass and a production method for producing an egg pastry substitute with the dough mass.

### CROSS-REFERENCE TO RELATED APPLICATION

The present application claims the filing date priority to European Patent Application No. EP24157335.1 filed on Feb. 13, 2024, the disclosure of which is incorporated in its entirety by reference herein.

### TECHNICAL FIELD

The invention relates to a dough mass for the production of a vegan egg pastry substitute as a long-life baked product, wherein the dough mass contains the following ingredients with the stated mass fractions of the dough mass: from 20% to 40% of flour, from 15% to 35% of sugar, from 10% to 30% of water, from 5% to 10% of vegetable fat and from 2.5% to 10% of a humectant.

The invention also relates to a vegan egg pastry substitute as a long-life baked product with the baked dough mass, a manufacturing method for manufacturing the dough mass and a production method for producing an egg pastry substitute as a long-life baked product with the dough mass.

### BACKGROUND

A survey conducted by vegan food manufacturer Veganz in 2020 revealed that 3.2% of the German population follow a vegan diet (https://veganz.com/blog/veganz-nutrition-study-2020/). The market for vegan baked goods therefore offers promising potential.

In Germany, the guidelines for fine bakery products must be observed for the food law assessment of egg pastries. The term “fine bakery products” refers to products made from dough or dough masses that are produced by baking, roasting, drying, cooking extrusion or other technological processes. They differ from bread and bread rolls in that they contain more than 10 parts fat and/or sugar per 90 parts cereals, cereal products and/or starch. Dough masses containing egg, such as sponge cake mass, Viennese mass, and egg pastry mass, are dough masses that are whipped during production in order to obtain a foamy texture.

According to the guidelines for fine bakery products, an egg pastry consists of cereal products, starches, sugar and whole egg or corresponding whole egg products. To be declared as an egg pastry, the egg content must be at least 18% of the quantity of cereal products and/or starches used. In contrast, the egg content of a sponge cake must be at least 66.7% of the quantity of cereal products and/or starches used, and the dough must be produced without the addition of fat. The use of the above-mentioned raw materials and the prescribed minimum quantity of 66.7% of whole egg also apply to a Viennese mass. However, at least 6% butter or the corresponding amount of milk fat products, margarine or practically anhydrous fats must be added in relation to the weight of cereal products and/or starches used.

In the preparation of fine bakery products that traditionally have a high egg content (e.g. sponge cake, egg pastry), various leguminous plants in the form of flours or protein isolates dominate as egg substitutes. These are increasingly being used due to their foaming and emulsifying properties.

The patent specification AU 2017200379 B2 discloses a composition of vegetable flour, wherein the vegetable flour is derived from chickpeas, field beans, sorghum, lentils, and lima beans, and at least one gum. The composition is used to functionally replace egg in a baked product, wherein the baked product is selected from muffins, cakes, cupcakes, brownies, cookies, biscotti, pancakes, waffles, pies, tarts, scones, pretzels and crackers.

The publication US 2023/172241 A1 describes a composition with ingredients of vegetable origin and chemical yeasts in powder form and its use as a substitute for eggs in the preparation of bakery and confectionery products. The ingredients of the composition are ground whole golden linseed, pea protein, pea starch, calcium diphosphate, monocalcium phosphate and sodium bicarbonate.

Lin et al. (Development of eggless cakes suitable for lacto-vegetarians using isolated pea proteins. Food Hydrocolloids, 2017, 69, 440-449. https://doi.org/10.1016/j.foodhyd.2017.03.014) investigate the addition of pea protein isolate in combination with xanthan gum and an emulsifier as a mixed ingredient in eggless cakes. The pea isolate is dosed at 3.48% in relation to the total batch. The results show that the protein-containing mixed ingredient is suitable as an egg substitute and produces a similar density of the raw mass, which thus confirms the foaming ability of pea protein isolate. However, the specific cake volume of the reference cannot be achieved.

The results of Lin et al. do not refer to a vegan recipe, but only to replacing chicken eggs in cakes with a protein-containing suspension. In addition, the compositions of sponge cakes and egg pastries differ significantly.

In a research project of the Fraunhofer Institute (Föste, M. (2019). Proteingele als Eiersatz. IVV Fraunhofer. https://www.ivv.fraunhofer.de/de/lebensmittel/pflanzliche-proteine/pflanzliche-proteine-als-eiersatz.html), various vegetable proteins are evaluated with regard to their suitability as egg substitutes in sponge cakes. The study on gel formation shows that the gel formation temperature is almost identical for proteins of the field bean concentrate and for proteins of chicken egg. In addition, a lower density is measured for the dough mass with field bean concentrate than for the reference with chicken egg. This means that field bean concentrate is comparable to chicken egg in terms of foaming ability.

Mustafa et al. (Aquafaba, wastewater from chickpea canning, functions as an egg replacer in sponge cake. International Journal of Food Science & Technology, 2018, 53(10), 2247-2255. https://doi.org/10.1111/ijfs.13813) investigate the use of a vegan egg white based on aquafaba, which is the cooking water from chickpeas, as an egg replacer in sponge cake. The results show that an egg-free recipe could be successfully developed using aquafaba, which comes close to the physicochemical properties of sponge cake with chicken egg.

None of the publications mentioned deals with the industrial production of vegan egg-based pastry substitutes, in particular with a filling and with a chocolate coating, and the resulting requirements for the vegan dough used, in particular with regard to the workability of the dough, the exact adherence to product specifications (including height, width, etc.) and the shelf life of the resulting end product as a long-life baked good.

Vegetable proteins are available in the form of flours, concentrates and isolates, among others, which differ significantly in their protein content. By definition, flours contain less than 50% protein. Concentrates have a protein content of between 50% and 80%, and isolates have a protein content of more than 80%.

Protein flours are produced by grinding press residues from oil extraction. Protein concentrates are additionally fractionated to remove oligosaccharides and minerals. To do this, the protein flours are washed in aqueous alcohol. The proteins and polysaccharides are insoluble in alcohol, while the oligosaccharides and minerals are soluble and are removed. The concentrate is then dried. To obtain the protein isolates, the components are first separated from each other as in the production of the concentrates due to their different solubility. As an additional step, the respective isoelectric point of the proteins is adjusted. This is where the proteins have the lowest solubility and precipitate. The proteins are then isolated by centrifugation or filtration.

### SUMMARY

The embodiments described herein provide a dough mass for a vegan egg pastry substitute, a vegan egg pastry substitute with the baked dough mass, a manufacturing method for the dough mass and a production method for a vegan egg pastry substitute with the dough mass, wherein the production process can be implemented cost-effectively on an industrial scale, and wherein the egg pastry substitute reproduces the physicochemical and sensory properties of an egg pastry, in particular the smell, taste and texture of an egg pastry. Furthermore, the vegan egg pastry substitute meets the requirements for a long-life baked product so that it has a very long shelf life and is suitable for long-term consumption.

### BRIEF DESCRIPTION OF THE DRAWINGS

FIG. 1 shows the bulk density of dough masses according to embodiments of the invention.

FIG. 2 shows the rheological behavior of dough masses according to embodiments of the invention.

FIG. 3 shows the influence of the protein mass in dough masses according to embodiments of the invention on the storage modulus.

FIG. 4 shows the residual moisture of egg pastry substitutes according to embodiments of the invention.

FIG. 5 shows the specific volume of egg pastry substitutes according to embodiments of the invention.

FIG. 6 shows the lightness value of egg pastry substitutes according to embodiments of the invention.

FIG. 7 shows the degree of deviation in odor of egg pastry substitutes according to embodiments of the invention from an egg pastry reference.

FIG. 8 shows the degree of deviation in texture of egg pastry substitutes according to embodiments of the invention from an egg pastry reference.

FIG. 9 shows the degree of deviation in taste of egg pastry substitutes according to embodiments of the invention from an egg pastry reference.

FIG. 10 shows detailed differences of egg pastry substitutes according to embodiments of the invention from an egg pastry reference regarding smell, hardness, stickiness and taste.

### DESCRIPTION

The present invention provides a dough mass according to claim 1 which solves the technical problem. Likewise, the task is solved by a vegan egg pastry substitute according to claim 5, a manufacturing method according to claim 6 and a production method according to claim 11. Advantageous embodiments are the subject of the dependent claims.

The dough mass according to the invention is designed for the production of a vegan egg pastry substitute. Thus, the dough mass is also vegan. The dough mass contains a mass fraction of the dough mass of 20% to 40%, preferably 25% to 35%, particularly preferably 25% to 30%, of flour, for example wheat flour, in particular wheat flour of type 700. Vitamins and/or minerals may be added to the flour. The dough mass contains a mass fraction of the dough mass of 15% to 35%, preferably 20% to 30%, particularly preferably 25% to 30%, of sugar, for example white sugar. The dough mass contains a mass fraction of the dough mass of 10% to 30%, preferably of 15% to 25%, particularly preferably of 20% to 25%, of water. The dough mass contains a mass fraction of the dough mass of 5% to 10%, preferably of 6% to 8%, particularly preferably of 7% to 8%, of vegetable fat, for example palm fat. The dough mass contains a mass fraction of the dough mass of 2.5% to 10%, preferably 3% to 8%, particularly preferably 4% to 5%, of a humectant, for example sorbitol. The dough mass may contain enzymes as a technical additive.

The dough mass contains a vegetable protein ingredient with a mass fraction of the dough mass of 1% to 5%, preferably 1% to 3%, particularly preferably 1% to 2%. The said mass fraction of the vegetable protein ingredient is, on the one hand, high enough to replace a usual proportion of egg in the dough mass and, on the other hand, low enough not to have any negative effects on industrial manufacturing or processing of the dough mass, for example in the form of reduced productivity.

The vegetable protein ingredient is preferably tasteless and/or odorless, so that an egg pastry substitute produced from the dough mass does not taste or smell like the vegetable protein ingredient.

The vegetable protein ingredient may be chemically, enzymatically and/or physically modified. The vegetable protein ingredient is preferably natural and/or unmodified.

The vegetable protein ingredient in combination with the other ingredients of the dough mass results in the dough mass having a foaming capacity, foam stability and viscoelastic behavior similar to that of an egg-containing dough mass, so that the dough mass can be processed on an industrial scale using production processes and production facilities designed for egg-containing dough masses. Furthermore, the dough mass can be used to bake an egg pastry substitute as a long-life bakery product that comes close to an egg pastry product in terms of specific volume, color, texture, smell, and taste.

### DETAILED DESCRIPTION OF PARTICULAR EMBODIMENTS

The vegetable protein ingredient is preferably obtained from peas, field beans and/or chickpeas. The vegetable protein ingredient is, for example, pea protein isolate. The vegetable protein ingredient obtained from the aforementioned plants results in easier machine processing of the dough mass and an egg pastry substitute with a crumb structure more similar to that of egg pastries than vegetable protein ingredients from other plants, for example from linseed, carrots or wheat. The vegan egg pastry substitute is suitable as a preliminary product for the production of a chocolate-coated pastry with a filling (e.g. jelly, jam, chocolate cream) as a long-life baked product.

The vegetable protein ingredient preferably has a protein mass fraction in a dry mass of the vegetable protein ingredient of at least 50%, preferably of at least 75%, particularly preferably of at least 80%. A high protein mass fraction leads to a particularly strong effect of the vegetable protein ingredient. The vegetable protein ingredient is, for example, a protein flour, a protein extract, or a protein isolate.

The vegetable fat preferably has a solid fat content of at least 10% at 20° C., preferably at least 15%, and/or a solid fat content of at least 5% at 30° C., preferably at least 10%. A high solid fat content advantageously leads to a high specific volume of an egg pastry substitute baked from the dough mass.

The dough mass preferably contains an emulsifier with a mass fraction in the dough mass of 0.2% to 0.8%, preferably of 0.4% to 0.6%.

The dough mass preferably contains starch with a mass fraction of the dough mass of 1% to 5%, preferably of 2% to 4%.

The dough mass preferably contains a raising agent with a mass fraction of the dough mass of 0.2% to 1.2%, preferably of 0.4% to 0.8%. The raising agent comprises, for example, sodium hydrogen carbonate, potassium hydrogen carbonate and/or ammonium hydrogen carbonate.

The dough mass preferably contains table salt with a mass fraction in the dough mass of 0.01% to 0.05%, preferably of 0.03%.

The vegan egg pastry substitute according to embodiments of the invention comprises a mass fraction of the vegan egg pastry substitute of 25% to 40% of the dough mass according to embodiments of the invention, wherein the dough mass is baked.

The vegan egg pastry substitute comprises a mass proportion of the vegan egg pastry substitute of 40% to 60% of a filling applied onto the baked dough mass. The filling can be water-based, in particular a jelly, a jam or a marmalade; or fat-based, in particular a cocoa cream. The filling can be a fruit jelly, in particular in the form of a fruit jelly lens.

The vegan egg pastry substitute comprises a mass fraction of the vegan egg pastry substitute of 15% to 25% of chocolate applied onto the filling, in particular in the form of a chocolate coating. For the purposes of the invention, the term “chocolate” comprises vegan chocolate substitutes.

The vegan egg pastry substitute thus corresponds, for example, to the egg pastry marketed by the applicant under the name “Soft Cake”, whereby the egg-containing dough mass of the “Soft Cake” is replaced by the dough mass according to embodiments of the invention. A “Soft Cake” consists of 28% of baked egg-based pastry dough, 55% of fruit jelly and 17% of chocolate.

The manufacturing method according to embodiments of the invention for producing the dough mass according to embodiments of the invention comprises adding the ingredients of the dough mass to a mixing container and mixing the ingredients in the mixing container. An aqueous suspension is prepared from the vegetable protein ingredient of the dough mass before the vegetable protein ingredient is added to the mixing container. The addition of the vegetable protein ingredient in the form of the aqueous suspension leads to a hydration of the proteins contained in the vegetable protein ingredient and thus to a homogeneous and faster mixing with the other ingredients, for example within two to six minutes, in particular within three to five minutes, preferably within four minutes, and thus to a robust, faster, and more efficient manufacturing method.

The aqueous suspension contains water with a mass fraction of the aqueous suspension of 60% to 80%, preferably of 65% to 75%, particularly preferably of 65% to 70%.

The aqueous suspension contains the vegetable protein ingredient with a mass fraction of the aqueous suspension of 10% to 20%, preferably of 12% to 18%, particularly preferably of 13% to 15%.

The aqueous suspension preferably contains a mass fraction of the aqueous suspension of 10% to 20%, preferably of 12% to 19%, particularly preferably of 14% to 18%, of syrup. The syrup assists in imparting color, in particular browning, to a top surface of a baked product baked from the dough mass during the baking process.

The vegetable fat of the dough mass is preferably added to the mixing container in a liquid state and/or before the other ingredients are added. Liquid vegetable fat is usually added as the last ingredient. Surprisingly, however, it has been found that a more homogeneous dough mass is produced if the liquid vegetable fat is added first.

The vegetable protein ingredient of the dough mass is preferably added to the mixing container after the other ingredients have been added. This also improves the homogeneity of the dough mass.

Mixing of the ingredients preferably comprises two mixing steps, for example each lasting one to three minutes, in particular two minutes. A first mixing step takes place before the vegetable protein ingredient is added to the mixing container, and a second mixing step takes place after the vegetable protein ingredient has been added to the mixing container. This also improves the homogeneity of the dough mass.

The production method according to embodiments of the invention is used for the production of a vegan egg pastry substitute, wherein the production method comprises manufacturing a dough mass according to embodiments of the invention using a manufacturing method according to embodiments of the invention.

The production method involves forming dough pieces from the dough mass on a baking support, for example on an oven belt. The dough pieces each have a mass of, for example, 5 g to 20 g, in particular of 10 g to 15 g, preferably of 12 g to 13 g.

The production method comprises baking the dough pieces on the baking support.

Baking is preferably carried out during a baking time of at least 5 minutes, preferably at least 10 minutes, and/or at a baking temperature of at least 280° C. With these parameters, a sufficient amount of water vapor can escape from the dough pieces so that the properties, in particular residual moisture, color and texture, of the baked dough pieces resemble the properties of an egg pastry.

Preferably, the baked dough pieces have a loss on drying of 12.5% to 16.5% and/or a water activity of 0.66 to 0.72, preferably of 0.70. This is advantageous for the shelf life of the baked dough pieces, in particular in the form of a chocolate-coated pastry with a filling as a long-life baked product.

A pastry color of the baked dough pieces preferably has a lightness value L* of 40 to 70, preferably 46 to 63, according to the L*a*b* color model (CIELAB color model), with the lightness axis extending from 0 (black) to 100 (white).

The production method preferably involves whipping the dough mass before the dough pieces are formed on the baking support. By whipping, the dough mass forms a foam, which results in a high specific volume of the baked dough pieces, as with an egg pastry.

After baking the dough pieces, the production method preferably comprises applying a solid or soft filling onto the baked dough pieces and coating the filling with chocolate. The filling can be water-based, in particular a jelly, a jam or a marmalade, or fat-based, in particular a cocoa cream. The filling is preferably a fruit jelly, in particular a fruit jelly lens.

The vegan egg pastry substitute preferably comprises a mass fraction of the vegan egg pastry substitute of 40% to 60% of filling, of 25% to 40% of baked dough mass, and of 15% to 25% of chocolate.

### EXAMPLES

In a series of tests, dough masses with different proportions of vegetable protein ingredients as egg substitutes are compared with each other and with an egg-containing dough mass as a reference. The dough masses consist of the following ingredients with the mass fractions of the respective dough mass specified in the table:

| | | 1% egg | 3% egg | 5% egg |
|---|---|---|---|---|
| Ingredient | Reference | substitute | substitute | substitute |
| sweetened chicken full | 37% | | | |
| egg | | | | |
| protein-containing plant | | 1.0% | 3.0% | 5.0% |
| extract | | | | |
| Water | | 17% | 15% | 13% |
| Syrup | | 3.4% | 3.4% | 3.4% |
| White sugar | | 16% | 16% | 16% |

| | |
|---|---|
| Humectant | 6.0% |
| Water | 5.1% |
| Emulsifier | 4.9% |
| Wheat flour type 700 | 30% |
| Strength | 3.21% |
| Evaporation table salt | 0.02% |
| Leavening agent | 0.64% |
| White sugar | 6.7% |
| Palm fat | 6.5% |

The vegetable protein ingredient is pea protein isolate with a protein mass fraction of 86% (hereinafter referred to as “pea”), a field bean protein concentrate with a protein mass fraction of 65% (hereinafter referred to as “field bean”), or powdered chickpea water with a protein mass fraction of 21% (hereinafter referred to as “aquafaba”).

The vegetable protein ingredient is first mixed with water, syrup, and white sugar to form an aqueous suspension (“slurry”).

The ingredients, except for the palm fat, are placed in a mixing bowl with a volume of 2 liters, for example. The slurry or whole egg is also added at this point. The ingredients are mixed in a planetary mixer with a whisk for 2 minutes at speed 2. In the meantime, the palm fat is melted, which is then allowed to run evenly into the mixture while continuing to stir at speed 1 for 1 minute. The dough mass is then structured in a mixer until a specific foam weight of (800±50) g/l is reached.

The dough is then spread evenly on baking paper using a 5 mm high template. The baking paper is placed on a preheated baking tray and baked for 14 minutes at 180° C. to 200° C. top and bottom heat in a radiant oven. Once the baked goods have cooled completely, the test samples are wrapped in airtight white foil and stored at 18° C. until the respective measurements are taken.

As a parameter for determining the foaming properties, the foaming capacity is measured by determining the bulk density of the dough mass, which is determined after mixing the ingredients. For this purpose, the raw mass is filled into a previously tared measuring cylinder with a volume of 0.1 l. The filled measuring cylinder is then weighed in order to determine the bulk density. The specific foam weight is determined in the same way. The specific foam weight is the density of the dough mass after successful whipping. A defined specific foam weight of the dough mass of (800±50) g/l is important from a production point of view in order to achieve standardized baking results.

In addition, the foam stability is determined to determine the foam properties. For this purpose, a cylindrical container with a lid is filled with the dough mass with a volume of 10 ml after setting the specific foam weight. The samples are stored at ambient temperature and the foam volume is read after 5 min, 1 h, 4 h and 24 h.

A halogen dryer of the type “Moisture Analyzer HX204” is used to measure the residual moisture of the egg pastry substitutes and of the pastry. At least 15 g of the baked goods are crushed for 10 s using a “CH580” food processor and 3 g of the crushed sample is weighed onto an aluminum tray in the dryer and evenly distributed. The sample is heated at 105° C. until less than 3 mg of water evaporates within 50 seconds. Consequently, the moisture content of the baked goods is calculated via the weight loss. The residual moisture is measured 3 hours after baking.

The color of the egg pastry substitutes and of the pastry is measured using a Hunter Lab “MiniScan EZ” colorimeter with a measuring aperture having a diameter of 12 mm. The color was recorded by the measuring device according to the L*a*b* color model, which consists of three axes. The lightness axis (L*) extends from +100 (white) to 0 (black). The greater the deviation of the red-green axis (a*) and the blue-yellow axis (b*) from the zero point, the more intense the respective color is. Together, the coordinate axes result in a three-dimensional color space. Before the measurement, the measuring device is calibrated with a white and a black surface. The sample is then held up to the opening of the measuring aperture to determine the L*, a* and b* values. The L* value is particularly important for the egg pastry and for the egg pastry substitutes, as it provides an indication of the degree of browning.

The volume of the pastry is determined using the “seed displacement method”. For this purpose, a 0.25-liter container is filled with rice crisps. The amount of rice crisps in the container is referred to as the zero volume. Samples are cut out of the pastries using a circular cutter (diameter 40 mm). The weight of each sample is then determined. The 0.25-liter container is filled halfway with the rice crisps of the zero volume. The cut-out pastries are then placed in the container. The container is then filled with the remaining rice crisps from the zero volume. The rice crisps of the zero volume that do not fit into the container are placed in a measuring cylinder to determine the volume of the displaced rice crisps and thus the volume of the pastries.

The rheological tests of the dough masses are carried out by means of amplitude tests with a rheometer of the type “MCR 302”. The test settings are listed in the following table:

| Parameters | Setting | |
|---|---|---|
| Temperature | 25° | C. |
| Angular frequency | 10 | rad/s |
| Amplitude | 0.001-100% | |
| Measuring geometry | Plate-plate | |
| Measuring gap width | 1 | mm |

Immediately after setting the defined specific foam weight, the dough masses are applied to the stationary plate. The measuring plate is then lowered to the set measuring gap width. Any material pressed out between the plates is then carefully removed from the edge. In addition, the sample is surrounded with oil. This is to prevent water from evaporating and the sample from drying out. This is followed by a short regeneration phase of 60 seconds. The measurement is then started.

The sensory evaluation of the pastries is carried out on the basis of selected samples using a sensory panel. Until the sensory tasting, the samples are packaged in a metallized film and stored at 18° C. for 6 days. The sensory properties were assessed using two different tests (difference from control and profile test with scale). The sensory tasting is carried out by 21 tasters who belong to the applicant's trained sensory panel. The sensory tests are carried out under red light so that the tasters are not influenced by visual impressions. Attention is paid to a uniform sample presentation.

The discriminatory test “Difference from Control” examines the question of whether a difference between the samples having different formulations is perceptible and whether this is significant. The aim of the “Difference from Control” is to determine the extent of the deviation between the samples and a reference. To do this, the differences between the samples are assessed using a difference scale and the deviation is described. The testers are first given an open reference (in this case egg pastry) to familiarize themselves with the standard. Subsequently, four samples including a concealed reference sample are presented, with the sample sequence rotating systematically from panelist to panelist. The tester assesses the samples in comparison to the open reference. The smell, texture and taste are considered.

In addition, the differences between the samples and the reference are quantified in the descriptive test “Profile test with scale”. For this purpose, the properties odor, texture, and taste are quantified using a scale. The following attributes are each rated on a scale of 1 to 5: Acceptability of odor, moisture, degree of softness, absence of stickiness, and acceptability of taste.

The foaming capacity of the proteins of different origins, i.e. the amount of air incorporated into the dough mass, is determined by the bulk density of the dough mass. The bulk density is determined after the ingredients have been mixed. During the mixing of the ingredients to form a homogeneous mass, air from the surrounding air atmosphere is also incorporated into the dough mass. The bulk density of the dough mass after mixing therefore shows the influence of the different types and quantities of protein on the foaming capacity. The lower the bulk density, the more gas bubbles are retained in the dough matrix.

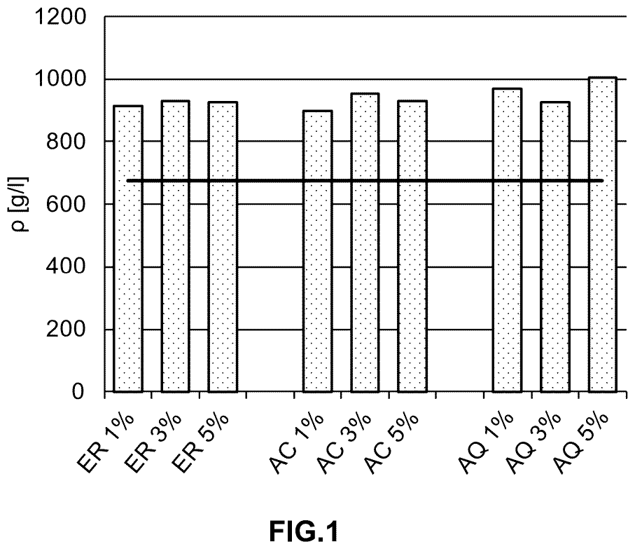

FIG. 1 shows the bulk density p of the dough masses with different types and quantities of vegetable protein ingredients (columns) compared to the reference with whole egg (horizontal line), which are achieved after a mixing time of 2 min at level 2 and 1 min at level 1 in the planetary mixer. In this and the following figures, a dough mass with 1%, 3% or 5% of pea protein isolate as the vegetable protein ingredient is designated as “ER 1%”, “ER 3%” or “ER 5%”. A dough mass with 1%, 3% or 5% of field bean concentrate as the vegetable protein ingredient is designated “AC 1%”, “AC 3%” or “AC 5%”. A dough mass with 1%, 3% or 5% of powdered chickpea water as the vegetable protein ingredient is designated “AQ 1%”, “AQ 3%” or “AQ 5%”.

It is clear to see that none of the vegan alternatives come close to the foaming capacity of the reference, which has a density of 676 g/l. The comparison of the test series shows that all the bulk densities of the doughs with pea, field bean or aquafaba are very close to each other. An influence of the dosage on the bulk density is not recognizable.

The stability of the foam after whipping is an important parameter for determining whether the mass is suitable for a certain standing time without a reduction in volume. In the production of egg-based pastries, process-related standing times of 30 min to 60 min occur. The foam volume remains unchanged for all samples during the maximum measurement period of 24 h. This means that the vegetable proteins stabilize the foam as well as the chicken whole egg.

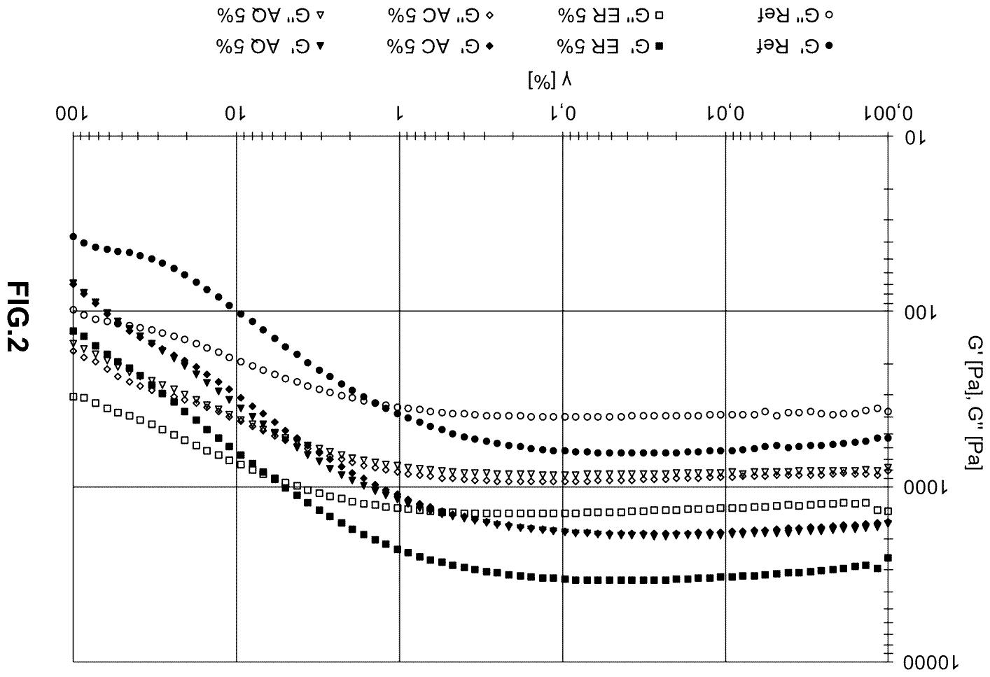

The rheological behavior of the dough masses is first described using the graphical representation of the curves shown in FIG. 2 for the storage modulus G′ (describes the elastic component, filled symbols in FIG. 2) and the loss modulus G″ (describes the viscous component, open symbols in FIG. 2) of the amplitude tests as a function of the relative shear deformation γ of the samples. For a better overview, FIG. 2 only shows the curves of the reference (here and in the following figures labeled “Ref”) and the dough masses with the highest dosage of the vegetable protein ingredients from pea, field bean and aquafaba.

All dough masses exhibit a plateau of the storage modulus G′ in an amplitude range of 0.01% to 0.1%. For each dough mass, the storage modulus G′ lies above the loss modulus G″ within the plateau (linear viscoelastic range, LVE range). The LVE range is the range in which there is no significant change in the sample structure despite deformation. This means that the elastic component dominates in the LVE range, and the samples have a gel character. The storage modulus G′ is used as a parameter to characterize the gel strength in the LVE range.

Above a certain shear deformation, the storage modulus G′ begins to drop and the LVE range is exited. The intersection of storage modulus G′ and loss modulus G″ is referred to as the yield point. Here, the gel character of the dough changes to a sol character in which the viscous component dominates. A defined shear stress T is required for the transition from gel to sol, which causes the dough to flow.

If all dough masses are compared in terms of their storage modulus G′ (elastic component of the sample), the samples can be ranked as follows: “Reference”< “Field bean”< “Aquafaba”< “Pea”. The same sequence also applies to the shear stress required for the respective dough mass to flow. The reference requires the least amount of energy, whereas the pea-containing samples require the most energy.

At a shear deformation of γ=0.0321%, the reference has the lowest storage modulus of 645 Pa. This means that the elastic component is the least pronounced in this dough mass and consequently the dough mass is the least elastic of all dough masses. This is also confirmed by the lowest shear stress of all dough masses at the yield point with 6.56 Pa. This dough mass requires by far the lowest shear stress for the dough mass to begin to flow.

The dough with pea has the most pronounced gel character in the LVE range. The maximum storage modulus is reached at the five percent dosage with 3435 Pa. It should be emphasized that the dough mass “Pea 5%” has the highest yield point of all dough masses at a shear stress of 77.6 Pa. For subsequent process steps, such as pumping processes or depositing, this means that the greatest energy is required for this dough mass so that the dough mass can be pumped or deposited at a constant process output.

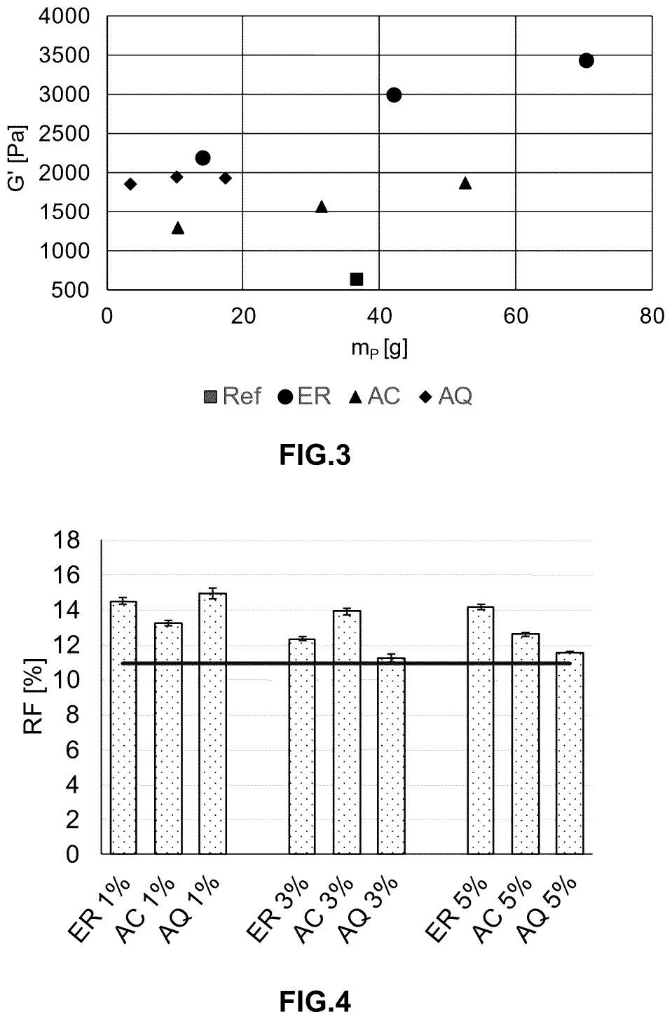

FIG. 3 shows the influence of the protein mass m_{P} per slurry unit of 293 g in the dough masses on the storage modulus G′ in the LVE range at a shear deformation γ=0.0321% compared to the reference dough mass with whole egg. For the dough masses “Pea” and “Field bean”, the storage modulus and thus the elasticity of the dough masses increases significantly with increasing protein quantity (“Pea 1%”: 2201 Pa, “Pea 5%”: 3435 Pa, “Field bean 1%”: 1292 Pa, “Field bean 5%”: 1861 Pa”). Only a slight increase can be seen for the “Aquafaba” dough masses (“Aquafaba 1%”: 1848 Pa, “Aquafaba 5%”: 1923 Pa).

The residual moisture comprises the free and bound water in a pastry. This also includes the result of the water holding capacity of the employed proteins. From a microbiological point of view, the moisture content of pastries is very important for compliance with the best-before date. The maximum permissible value of residual moisture is between 9% and 11% for disc-shaped egg pastries.

FIG. 4 shows the residual moisture RF of egg pastry substitutes made with different types and quantities of vegetable protein ingredients (columns) compared to the residual moisture of the egg-based pastry made from the reference dough with whole egg (horizontal line). The lowest residual moisture of all pastries was determined for the reference at 11%.

Within the 1% dosage of the vegetable protein ingredient, the pastry with aquafaba has the highest residual moisture, followed by pea and field bean. For the three-percent and five-percent dosage, the highest residual moisture is found in the pastries with field bean and pea, and the residual moisture with aquafaba is significantly lower. The residual moisture of the pastries with aquafaba at three and five percent dosage is similar to the residual moisture of the reference.

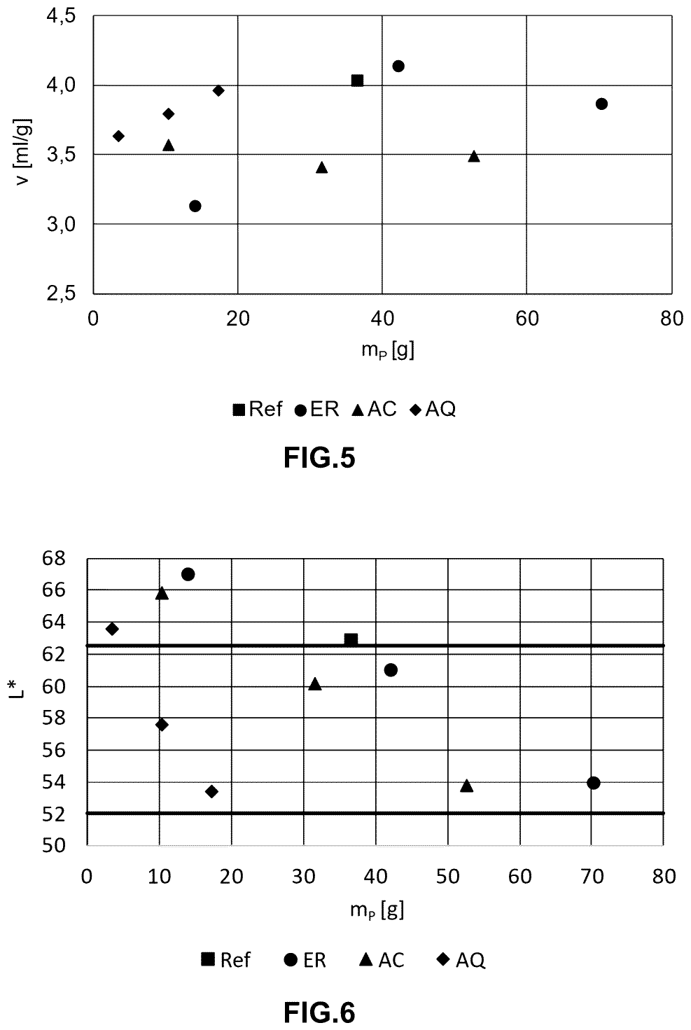

The specific volume of the pastries is an important criterion for evaluating the pastries. The volume can be used to assess the stability of the protein matrix. This is because the better the air introduced during whipping is stabilized by the emulsifying properties of the proteins in the raw mass and the better the gas bubbles are retained in the dough matrix during the baking process, the higher the resulting specific volume. FIG. 5 shows the specific volume v of the baked goods as a function of the protein type and protein mass m_{P} per slurry unit of 293 g compared to the reference. It should be emphasized that the specific foam weight of all dough masses was set to (800±50) g/l before baking, so that the same conditions apply to all samples with regard to trapped gas bubbles in the dough matrix.

The largest specific volumes are achieved by the samples “Pea 3%”, “Reference” and “Aquafaba 5%”. Consequently, the pastries are fluffy with a lot of trapped air. With a protein quantity of 37 g, the “Reference” pastry achieves a specific volume of 4.0 ml/g. The pea proteins achieve a comparable specific volume of 4.1 ml/g with a slightly increased amount of protein (42 g). The aquafaba proteins achieve a similar specific volume of 4.0 mg/l, but only 17 g of protein is required for this volume. For the series of experiments with aquafaba, the specific volume increases with increasing protein dosage. The test series with pea and field bean, on the other hand, show no correlation between protein quantity and specific volume.

Pastry browning is another quality characteristic of a pastry. In this respect, the influence of vegetable proteins on browning is investigated with regard to protein type and protein mass m_{P} per slurry unit of 293 g and shown in FIG. 6. The L* value of the individual pastries, which ranges from 100 (white) to 0 (black), is decisive for the browning of the pastries. This means that the lower the L* value, the greater the degree of browning.

An L* value of 63 is determined for the reference. The degree of browning of the vegan pastries decreases depending on the type of vegetable protein ingredient in the following order: “Aquafaba”>“Field Bean”>“Pea”. As the protein dosage increases, the browning of the pastries increases for all protein types. At three-percent and five-percent dosage, the degree of browning for all protein types is in the target range of an L* value of 52 to 62.5 (horizontal lines in FIG. 6). The “Pea 3%” and “Field bean 3%” pastries reproduce the browning of the reference best.

The “Difference from Control” test is used to check whether the pastry samples with vegetable protein ingredients differ from the reference pastry sample with whole egg. For this purpose, the following four samples are blind-tasted against the openly served reference: “Reference”, “Pea 3%”, “Field bean 3%” and “Aquafaba 3%”. One of the four comparative samples thus represents the reference as a control. With regard to this test, it is necessary to limit the number of samples so that the sensory perception of the tasters does not become too fatigued over the duration of the tasting. As the 3% dosage of the vegetable protein ingredient replicates most of the physicochemical features of the reference, this dosage is used for the sensory tastings. The influence of the vegetable proteins was characterized with regard to the parameters of smell, texture, and taste.

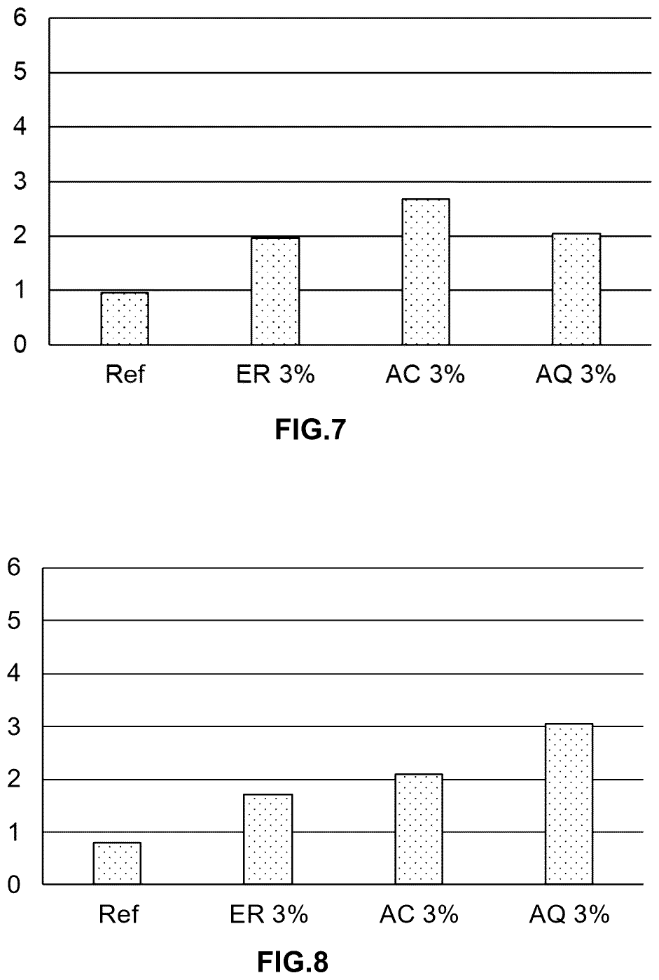

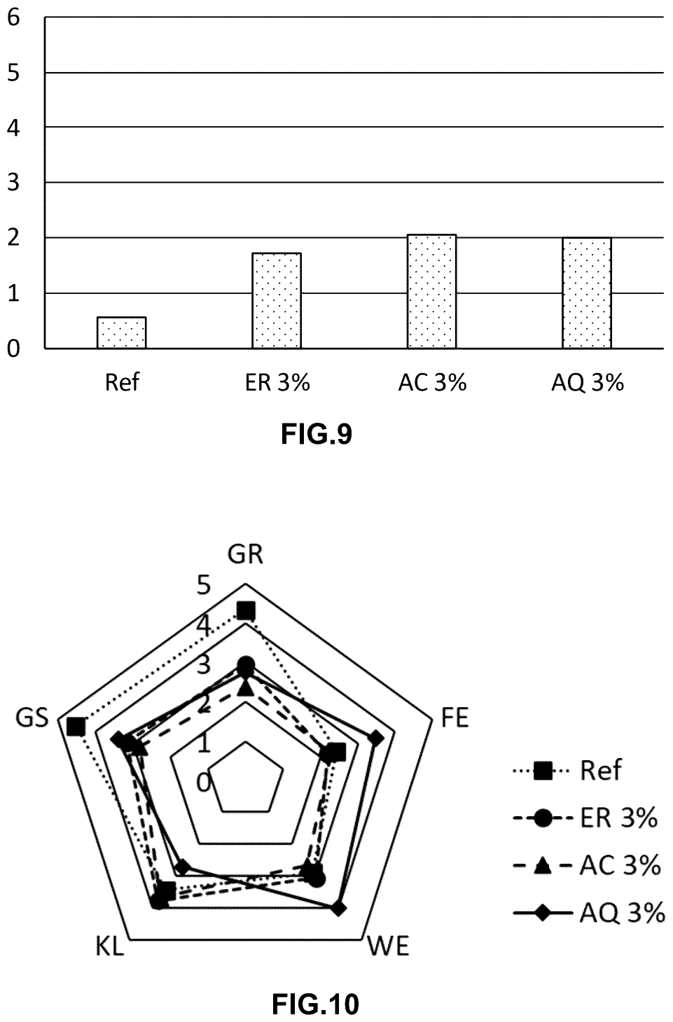

FIGS. 7 to 9 show the degree of deviation from the open reference in the parameters odor (FIG. 7), texture (FIG. 8) and taste (FIG. 9) on a scale from 0 (no difference) to 6 (very large difference).

With regard to the odor, FIG. 7 shows that the “Field bean 3%” sample has a significant difference to the reference. Four people noted that a foreign note was perceptible in the odor of the “Field bean 3%” sample and that the odor note “egg” was absent or less perceptible. The samples “Pea 3%” and “Aquafaba 3%” did not differ significantly from either the reference or from “Field bean 3%”.

With regard to texture, it can be noted (FIG. 8) that there is again no significant difference between the “Pea 3%” and “Reference” samples. In contrast, significant differences were found for the test samples “Field bean 3%” and “Aquafaba 3%” compared to the “Reference”. In contrast to the odor parameter, the test sample “Aquafaba 3%” was evaluated as the most different from the openly served reference. The pastry with aquafaba was described by the sensory panel as softer and stickier than the reference.

There are clear results regarding the influence of the plant proteins on the taste (FIG. 9). The “Reference” sample differs significantly from the three vegan samples. Seven people note that the pastries tasted sweeter with aquafaba. Four panelists note a missing or weakened egg note with aquafaba. A more floury and sweeter taste perception was mentioned most frequently for the test sample with pea. In the comments on the pastry with field bean, a different side taste and an off-note in the aftertaste were mentioned most frequently.

In addition to the “Difference from Control” test, the “Profile test with scale” is used to characterize the detailed differences in smell, texture (moisture, hardness, and stickiness) and taste. The results are shown in FIG. 10 in a spider web diagram. The evaluation is based on a five-point scale. The following scaling applies to the respective parameters: odor GE: 0=not accepted to 5=accepted; moisture FE: 0=very dry to 5=very moist; softness WE: 0=very hard to 5=very soft; Absence of stickiness KL: 0=sticks to the palate to 5=does not stick to the palate; taste GS: 0=not accepted to 5=accepted.

Overall, there are significant differences between the four samples tasted with regard to all the parameters examined, with the exception of the stickiness parameter. With regard to the acceptance of the smell, it can be seen that the smell of the “Reference” sample was significantly more accepted by the tasters than the vegan pastries. The results for the parameters moisture and hardness show that the “Aquafaba 3%” pastry is perceived as significantly softer and moister than the reference. The samples with “Field bean 3%” and “Pea 3%” do not differ significantly from the reference in terms of the two parameters moisture and hardness. Due to the large variances in the evaluation of the stickiness parameter, no significant differences between the reference and the vegan pastries can be determined. With regard to the acceptance of the taste, the “Reference” sample was the most accepted, analogous to the odor parameter, and differs significantly from the vegan pastries.

In conclusion, the profile test with scale shows that the “Reference” sample was best accepted in terms of odor and taste, followed by the “Pea 3%” and “Aquafaba 3%” pastries. In terms of hardness and moisture, the samples “Pea 3%” and “Field bean 3%” correspond to the reference.

The investigations of exemplary dough masses according to embodiments of the invention with vegetable protein ingredients show that the dough masses investigated are suitable for producing a vegan egg pastry substitute as a long-life pastry product which imitates the properties of egg pastry products. Of the doughs tested, the “Pea 3%” recipe is favored because it most convincingly replicates the physicochemical features of egg pastries and achieves the highest level of consistency with the sensory perception of egg pastries.

1. A vegan dough mass for the production of a vegan egg pastry substitute as a long-life baked good, comprising:
a. from 20% to 40% flour as a fraction of the total mass of the vegan dough;
b. from 15% to 35% sugar as a fraction of the total mass of the vegan dough;
c. from 15% to 30% water as a fraction of the total mass of the vegan dough;
d. from 5% to 10% vegetable fat as a fraction of the total mass of the vegan dough, the vegetable fat having a solid fat content of at least 10% at 20° C. or a solid fat content of at least 5% at 30° C.;
e. from 1% to 5% of a vegetable protein ingredient obtained from peas, field beans or chickpeas as a fraction of the total mass of the vegetable protein ingredient having a protein mass fraction of at least 50% of a dry mass of the vegetable protein ingredient; and
f. a humectant with a mass fraction of the vegan dough mass of from 4% to 10%.

2. The vegan dough mass according to claim 1,
wherein the vegetable protein ingredient has a protein mass fraction of a dry mass of the vegetable protein ingredient of at least 75%.

3. The vegan dough mass according to claim 1,
wherein the vegetable fat has a solid fat content of at least 15% at 20° C. or a solid fat content of at least 10% at 30° C.

4. The vegan dough mass according to claim 1,
wherein the vegan dough mass contains the following ingredients with the stated mass fractions of the vegan dough mass:
a. from 0.2% to 0.8% emulsifier,
b. from 1% to 5%, starch,
c. from 0.2% to 1.2%, raising agents, or
d. from 0.01% to 0.05% table salt.

5. A vegan egg pastry substitute comprising:
from 25% to 40% as a fraction of the mass of a baked vegan dough, the baked vegan dough including
a. from 20% to 40% flour as a fraction of the total mass of the baked vegan dough,
b. from 15% to 35% sugar as a fraction of the total mass of the baked vegan dough,
c. from 15% to 30% water as a fraction of the total mass of the baked vegan dough,
d. from 5% to 10% vegetable fat as a fraction of the total mass of the baked vegan dough, the vegetable fat having a solid fat content of at least 10% at 20° C. or a solid fat content of at least 5% at 30° C.,
e. from 1% to 5% of a vegetable protein ingredient obtained from peas, field beans or chickpeas as a fraction of the total mass of the baked vegan dough, the vegetable protein ingredient having a protein mass fraction of at least 50% of a dry mass of the vegetable protein ingredient, and
f. a humectant with a mass fraction of the baked vegan dough mass of from 4% to 10% from 40% to 60% of a filling applied onto the baked vegan dough mass; and
from 15% to 25% of chocolate applied onto the filling in the form of a chocolate coating.

6. A method for manufacturing a vegan dough mass, comprising:
preparing an aqueous suspension from a vegetable protein ingredient obtained from peas, field beans or chickpeas as a fraction of the total mass of the vegetable protein ingredient having a protein mass fraction of at least 50% of a dry mass of the vegetable protein ingredient;
adding the aqueous suspension into a mixing container as a fraction of a total mass of a vegan dough in the mixing container in the range of 1% to 5% of that mass;
adding from 20% to 40% flour as a fraction of the total mass of the vegan dough in the mixing container;
adding from 15% to 35% sugar as a fraction of the total mass of the vegan dough in the mixing container;
adding from 15% to 30% water as a fraction of the total mass of the vegan dough in the mixing container;
adding from 5% to 10% vegetable fat as a fraction of the total mass of the vegan dough in the mixing container, the vegetable fat having a solid fat content of at least 10% at 20° C. or a solid fat content of at least 5% at 30° C.;
adding a humectant with a mass fraction of the vegan dough mass in the mixing container of from 4% to 10%; and
mixing the aqueous suspension, flour, sugar, water, vegetable fat, and humectant in the mixing container to thereby yield the vegan dough mass.

7. The method according to claim 6,
wherein the aqueous suspension contains the following components with the stated mass fractions of the aqueous suspension:
a. from 60% to 80% of water, and
b. from 10% to 20% of the vegetable protein ingredient.

8. The method according to claim 6,
wherein the vegetable fat of the vegan dough mass is added to the mixing container in a liquid state and before the other components of the vegan dough mass are added.

9. The method according to claim 6,
wherein the aqueous suspension is added to the mixing container after the other components of the vegan dough mass have been added.

10. The method according to claim 6,
wherein mixing the ingredients comprises at least two mixing steps, wherein a first mixing step takes place before adding the aqueous suspension to the mixing container, and a second mixing step takes place after adding the aqueous suspension to the mixing container.

11. A method for producing a vegan egg pastry substitute, comprising:
preparing an aqueous suspension from a vegetable protein ingredient obtained from peas, field beans or chickpeas as a fraction of the total mass of the vegetable protein ingredient having a protein mass fraction of at least 50% of a dry mass of the vegetable protein ingredient;
adding the aqueous suspension into a mixing container as a fraction of a total mass of a vegan dough in the mixing container in the range of 1% to 5% of that mass;
adding from 20% to 40% flour as a fraction of the total mass of the vegan dough in the mixing container;
adding from 15% to 35% sugar as a fraction of the total mass of the vegan dough in the mixing container;
adding from 15% to 30% water as a fraction of the total mass of the vegan dough in the mixing container;
adding from 5% to 10% vegetable fat as a fraction of the total mass of the vegan dough in the mixing container, the vegetable fat having a solid fat content of at least 10% at 20° C. or a solid fat content of at least 5% at 30° C.;
adding a humectant with a mass fraction of the vegan dough mass in the mixing container of from 4% to 10%;
mixing the aqueous suspension, flour, sugar, water, vegetable fat, and humectant in the mixing container to thereby yield the vegan dough mass;
forming dough pieces from the vegan dough mass on a baking support; and
baking the dough pieces on the baking support.

12. The method according to claim 11, wherein baking the dough pieces takes place during a baking time of at least 5 min, or at a baking temperature of at least 280° C.

13. The method according to claim 11, further comprising whipping the vegan dough mass prior to forming the dough pieces on the baking support.

14. The method according to claim 11, further comprising
a. applying a filling onto the baked dough pieces, and
b. coating the filling with chocolate;
wherein the vegan egg pastry substitute comprises the following mass fractions of the vegan egg pastry substitute:
c. from 40% to 60% filling,
d. from 25% to 40% baked dough mass, and
e. from 15% to 25% chocolate.
